(19) United States
(12) Patent Application Publication
(10) Pub. No.: US 2013/0215018 A1
(43) Pub. Date: Aug. 22, 2013

(54) TOUCH POSITION LOCATING METHOD, TEXT SELECTING METHOD, DEVICE, AND ELECTRONIC EQUIPMENT

(71) Applicants: Gang XU, Tianjin (CN); Peng SUN, Beijing (CN)

(72) Inventors: Gang XU, Tianjin (CN); Peng SUN, Beijing (CN)

(73) Assignee: SONY MOBILE COMMUNICATIONS AB, Lund (SE)

(21) Appl. No.: 13/616,703

(22) Filed: Sep. 14, 2012

(30) Foreign Application Priority Data
Feb. 20, 2012 (CN) 201210039250.7

(51) Int. Cl. G06F 3/041; G06F 3/033

(52) U.S. Cl. 345/157

(57) ABSTRACT

A touch position locating method, text selecting method, device, and an electronic equipment. The touch position locating method including: acquiring position movement information from a gravity and acceleration sensor; calculating movement direction and distance of a cursor displayed on a touch screen according to the position movement information; and controlling a display position of the cursor according to the movement direction and distance of the cursor. The beneficial effect of the embodiments of the present invention is as follows: by swaying or slanting the electronic equipment having a touch screen, the display position of the cursor is controlled using the position movement information sensed by the gravity and acceleration sensor to accurately locate a point or select a text area, thereby improving the location accuracy of the touch screen and the user's experience.

### FIELD OF THE INVENTION

The present invention relates to the electronic field, and particularly, to a touch position locating method, text selecting method, device, and an electronic equipment including the device.

### DESCRIPTION OF THE RELATED ART

With the rapid development of the electronic technology, more and more touch screen electronic equipments appear, such as the touch screen mobile phone, touch screen navigator and touch screen game console, which respond to a touch by the user's finger or the stylus and convert the touch into an operation or control instruction for the touch screen electronic equipment. Since the physical keyboard is saved, the display area of the slim type electronic equipment is effectively extended, thus the user's experience is improved.

### SUMMARY OF THE INVENTION

However, the inventor has found that for most smart phones with big screens and revolution, the capacitive touch screen is preferred now, but there is a natural defect, namely, touch precision is worse. In other words, it is hard to touch on one point precisely as compared to a resistance touch screen with a touch pen because the finger always touches in one circle region, not one point. If it is required to locate one point precisely on screen, it is not wise to try touching several times with a finger or it is impossible. In addition, for a touch screen mobile phone, it is also difficult to select an area such as multiple characters in a text. For example, in order to magnify a text on the application interface of the touch screen mobile phone through a magnifier, the user must continuously touch the display screen downwards, while once the finger starts to move, the content magnified by the magnifier varies with the touch point. So it is very difficult to select a part of content in the magnifier.

The present invention is proposed with respect to the above problem of the prior art.

The present invention provides a touch position locating method, text selecting method, device, and an electronic equipment, so as to solve the problem of the prior art that a point cannot be precisely located on the electronic equipment using the capacitive touch screen, or the content of an area such as multiple lines of characters cannot be selected.

According to a first aspect of the present invention, a touch position locating method is provided, including:

acquiring position movement information from a gravity and acceleration sensor;

calculating movement direction and distance of a cursor displayed on a touch screen according to the position movement information; and

controlling a display position of the cursor according to the movement direction and distance of the cursor.

According to a second aspect of the present invention, a text selecting method is provided, including:

determining an initial display position of a cursor displayed on a touch screen;

acquiring position movement information from a gravity and acceleration sensor;

calculating movement direction and distance of the cursor according to the position movement information;

determining a current display position of the cursor according to the movement direction and distance of the cursor; and

selecting a text of an area from the initial display position to the current display position as a target text.

According to a third aspect of the present invention, a method of the first or second aspect is provided, wherein the position movement information includes any combination of: a movement direction; a movement speed; and a movement distance.

According to a fourth aspect of the present invention, a method of the first or second aspect is provided, wherein the cursor is a cross cursor, an arrow cursor or a blinking cursor.

According to a fifth aspect of the present invention, a touch position locating device is provided, including:

an acquiring unit for acquiring position movement information from a gravity and acceleration sensor;

a calculating unit for calculating movement direction and distance of a cursor displayed on a touch screen according to the position movement information; and

a controlling unit for controlling a display position of the cursor according to the movement direction and distance of the cursor.

According to a sixth aspect of the present invention, a text selecting device is provided, including:

a first determining unit for determining an initial display position of a cursor displayed on a touch screen;

an acquiring unit for acquiring position movement information from a gravity and acceleration sensor;

a calculating unit for calculating movement direction and distance of the cursor according to the position movement information;

a second determining unit for determining a current display position of the cursor according to the movement direction and distance of the cursor; and

a selecting unit for selecting a text of an area from the initial display position to the current display position as a target text.

According to a seventh aspect of the present invention, an electronic equipment having a touch screen is provided, wherein the electronic equipment including:

a position sensing device for sensing a movement of the electronic equipment to generate position movement information;

a touch detecting device for detecting a user's touch operation on the touch screen of the electronic equipment to generate touch operation information; and

a touch position locating device for acquiring the position movement information from the position sensing device, calculating movement direction and distance of a cursor according to the position movement information, controlling a display position of the cursor according to the movement direction and distance of the cursor, acquiring the touch operation information from the touch detecting device, and determining a touch position according to the touch operation information.

According to an eighth aspect of the present invention, an electronic equipment having a touch screen is provided, wherein the electronic equipment including:

a position sensing device for sensing a movement of the electronic equipment to generate position movement information;

a touch detecting device for detecting a user's touch operation on the touch screen of the electronic equipment to generate touch operation information; and

a text selecting device for determining an initial display position of a cursor displayed on a touch screen, acquiring position movement information from the position sensing device, calculating movement direction and distance of the cursor according to the position movement information, determining a current display position of the cursor according to the movement direction and distance of the cursor, and selecting a text of an area from the initial display position to the current display position as a target text.

According to a ninth aspect of the present invention, an electronic equipment of the seventh or eighth aspect is provided, wherein the position sensing device is a gravity and acceleration sensor.

According to a tenth aspect of the present invention, an electronic equipment of the seventh or eighth aspect is provided, wherein the touch detecting device is connected to the touch screen of the electronic equipment.

The embodiments of the present invention have the following beneficial effect: by swaying or slanting the electronic equipment having a touch screen, the display position of the cursor is controlled using the position movement information sensed by the gravity and acceleration sensor to precisely locate a point or select a text area, thereby improving the location accuracy of the touch screen and the user's experience.

These and further aspects and features of the present invention will be apparent with reference to the following description and attached drawings. In the description and drawings, particular embodiments of the invention have been disclosed in detail as being indicative of some of the ways in which the principles of the invention may be employed, but it is understood that the invention is not limited correspondingly in scope. Rather, the invention includes all changes, modifications and equivalents coming within the spirit and terms of the appended claims.

Features that are described and/or illustrated with respect to one embodiment may be used in the same way or in a similar way in one or more other embodiments and/or in combination with or instead of the features of the other embodiments.

It should be emphasized that the term “comprises/comprising” when used in this specification is taken to specify the presence of stated features, integers, steps or components but does not preclude the presence or addition of one or more other features, integers, steps, components or groups thereof.

Many aspects of the invention can be better understood with reference to the following drawings. The components in the drawings are not necessarily to scale, emphasis instead being placed upon clearly illustrating the principles of the present invention. To facilitate illustrating and describing some parts of the invention, corresponding portions of the drawings may be exaggerated in size, e.g., made larger in relation to other parts than in an exemplary device actually made according to the invention. Elements and features depicted in one drawing or embodiment of the invention may be combined with elements and features depicted in one or more additional drawings or embodiments. Moreover, in the drawings, like reference numerals designate corresponding parts throughout the several views and may be used to designate like or similar parts in more than one embodiment.

### BRIEF DESCRIPTION OF THE DRAWINGS

The included drawings provide further understandings of the present invention, and constitute a part of the Specification. The drawings illustrate the preferred embodiments of the present invention and elaborate the principle of the present invention together with the literal descriptions, wherein the same element is always represented with the same reference numeral. In which the drawings,

FIG. 1 is a flowchart of a touch position locating method in accordance with an embodiment of the present invention;

FIG. 2A is a schematic diagram of a display interface of a smart phone with the browse map function activated;

FIG. 2B is a schematic diagram of the movement of a cross cursor on the display interface after the smart phone of FIG. 2A is swayed or slanted;

FIG. 3 is a flowchart of a target area locating method according to the method of an embodiment;

FIG. 4A is a schematic diagram of a display interface of a smart phone with the magnifier function activated;

FIG. 4B is a schematic diagram of a locked display area in the magnifier on the display interface after the smart phone of FIG. 4A is swayed or slanted;

FIG. 5 is a constitutional diagram of a touch position locating device in accordance with an embodiment of the present invention;

FIG. 6 is a constitutional diagram of a text selecting device in accordance with an embodiment of the present invention;

FIG. 7 is a constitutional diagram of an electronic equipment in accordance with an embodiment of the present invention; and

FIG. 8 is a constitutional diagram of an electronic equipment in accordance with another embodiment of the present invention.

### DETAILED DESCRIPTION OF THE PREFERRED EMBODIMENTS

The interchangeable terms “electronic device” and “electronic apparatus” include the portable radio communication device. The term “portable radio communication device” (hereinafter referred to as “mobile radio terminal”, “portable electronic apparatus” or “portable communication apparatus”) includes devices such as mobile phone, pager, communication apparatus, electronic diary, personal digital assistant (PDA), smart phone, portable communication apparatus, etc.

In the present application, the embodiments of the present invention are mainly described with respect to the portable electronic apparatus in a form of mobile phone (also referred to as “cell phone”). However, it shall be appreciated that the present invention is not limited to the mobile phone, and may relate to an electronic device of any appropriate type, e.g., media player, game device, PDA, computer, digital camera, etc.

The preferred embodiments of the present invention are described as follows with reference to the drawings.

### Embodiment 1

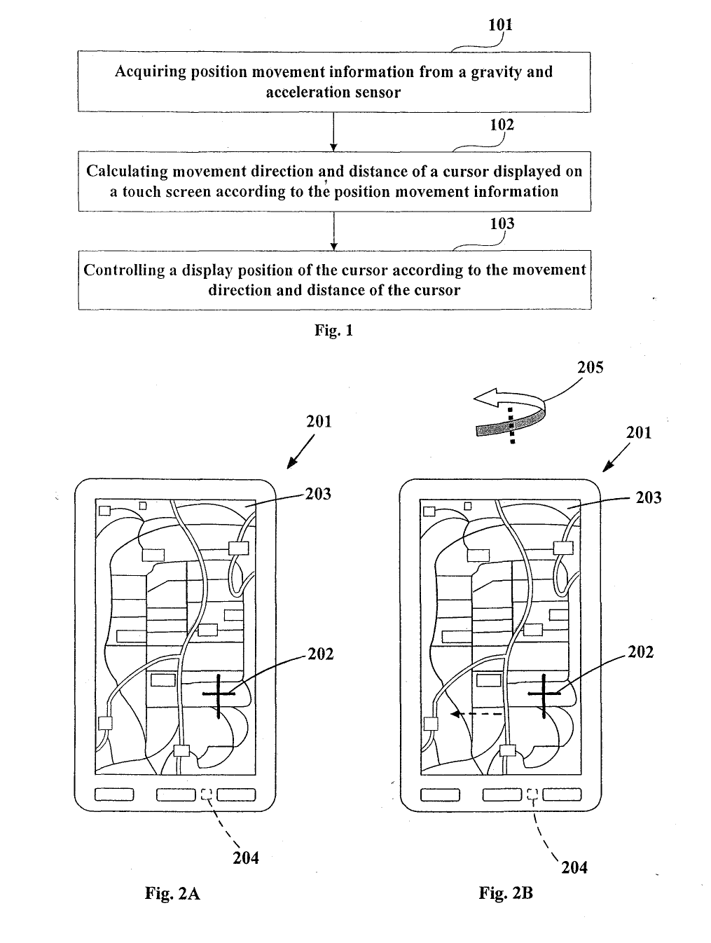

According to an embodiment of the present invention, a touch position locating method is provided. FIG. 1 is a flowchart of the method, and referring to FIG. 1, the method includes:

Step 101: acquiring position movement information from a gravity and acceleration sensor;

Step 102: calculating movement direction and distance of a cursor displayed on a touch screen according to the position movement information; and

Step 103: controlling a display position of the cursor according to the movement direction and distance of the cursor.

Through the method of the embodiment, the touch position can be determined according to the user's touch operation on the touch screen.

In the embodiment, the method is used in an electronic equipment having a touch screen. In order to support the method of the embodiment, the work modes of the touch screen of the electronic equipment may be set in two types, for example a common touch mode and an accurate touch mode. The common touch mode is the touch mode of the touch screen of the electronic equipment in the prior art. When the common touch mode is activated, corresponding touch operation information is generated by detecting the user's finger touch on the touch screen, and is transmitted to a controller of the electronic equipment. Then the controller performs corresponding control and feedback according to the touch operation information. The accurate touch mode may be a work mode that uses the touch position locating method of the embodiment of the present invention. When the accurate touch mode is activated, a cursor is displayed on the application interface of the electronic equipment. The position movement information is acquired by swaying or slanting the electronic equipment, and the movement direction and distance of the cursor are calculated according to the position movement information. Then the display position of the cursor is controlled according to the movement direction and distance of the cursor. Thus, the touch position can be determined according to the user's operation on the touch screen.

In Details:

In step 101: the position movement information may be acquired by swaying or slanting the electronic equipment. For example, corresponding position movement information is generated by detecting (sensing) the movement of the electronic equipment through a position sensing device thereof such as a gravity and acceleration sensor, and provided for the method of the embodiment. The position movement information may be movement direction, movement speed and/or displacement of the electronic equipment.

In step 102, since the coordinates of the cursor displayed on the touch screen are known, after the electronic equipment is swayed or slanted, the movement direction and distance of the cursor may be calculated according to the position movement information of the electronic equipment, such as the movement direction, the movement speed and/or the displacement.

In step 103, the display position of the cursor on the touch screen may be controlled according to the movement direction and distance of the cursor. For example, if the electronic equipment is swayed rightwards, the calculated movement direction of the cursor is rightward relative to the display position of the original coordinates of the cursor. In contrast, if the electronic equipment is swayed leftwards, the calculated movement direction of the cursor is leftward relative to the display position of the original coordinates of the cursor. The movement distance of the cursor may also be calculated according to the position movement information.

In the embodiment, with the movement direction and distance of the cursor, the touch position can be determined according to the user's touch operation on the touch screen. For example, when the touch operation information of the user for the cursor on the touch screen is received, the display position of the cursor is determined as the touch position. That is, the user acquires the new display position of the cursor by swaying the electronic equipment, and the purpose of accurate location can be achieved by clicking the position-moved cursor.

To further describe the embodiment, an example is given as follows.

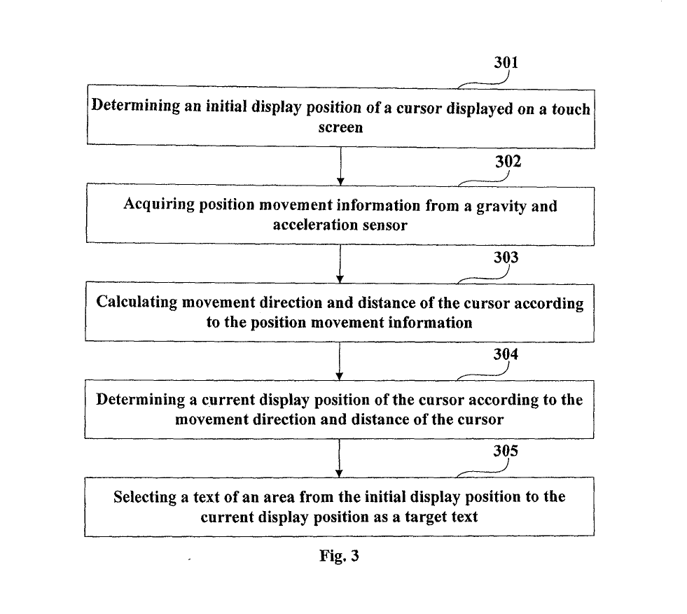

FIG. 2A is a schematic diagram of a smart phone 201 with the browse map function activated. FIG. 2B is a schematic diagram of applying the method of the embodiment to control a cursor 202 to move leftwards by swaying the smart phone. Please refer to FIGS. 2A and 2B.

In the embodiment, there are two work modes for performing a touch operation on the touch screen 203 of the smart phone 201. One is the normal touch mode in which the user can directly touch a point with the finger, but the position is not accurate enough. The other is the accurate touch mode in which the smart phone performs an accurate location according to the method of the embodiment. In that case, the user may touch a point in two steps: firstly, move the cursor 202 on the touch screen of the smart phone to the required position by swaying the smart phone, and secondly, touch the cursor with a finger to locate the position. In the embodiment, the cursor may be a cross cursor, an arrow cursor or a cursor of other form. Herein the embodiment takes the cross cursor as an example. When a point needs to be accurately touched in some special applications, such as map browse, stock chart analysis, or selection of a text on a webpage, the user may enter the accurate touch mode and perform an accurate location according to the method of the embodiment.

Please refer to FIG. 2A, under the accurate touch mode, there is a cross cursor 202 on the browse map user interface of the touch screen 203 of the smart phone 201. When the user wants to see the aerial view of a whole city, the map of the whole city is zoomed out onto a small touch screen. That is, many details of the city map are not easy to be seen. If it is required to find a shortcut between two positions (points) on the map, the start point and the end point would be marked at first, and according to the method of the embodiment, a point can be accurately located on the small and complex map.

Referring to FIG. 2B, firstly the smart phone 201 is swayed or slanted, and a gravity and acceleration sensor 204 embedded in the smart phone will sense the movement to generate corresponding position movement information. According to the method of the embodiment, the movement direction and distance of the cross cursor 202 is calculated according to the position movement information, and on this basis, the display position of the cross cursor on the browse map interface of the touch screen is controlled. That is, when the user sways and/or slants the smart phone 201, the cross cursor 202 on the map also slowly moves step by step.

Next, once the start point or the end point is determined, the user may touch the cross cursor 202 with a finger. According to the method of the embodiment, the touch detection device connected to the touch screen 203 detects the touch operation, and generates corresponding touch operation information, based on which corresponding control and feedback can be carried out. In spite of the finger touching more points, the event of touch down and up happens on the point of the cross cursor 202, and can be deemed as touch operations on the cross cursor.

Finally, once a point on the map is visible, it can be accurately located on the map according to the method of the embodiment.

As illustrated in FIG. 2B, when the smart phone 201 is swayed or slanted from right to left, the cross cursor 202 will move leftwards. The movement speed and step may be determined according to the slant angle and/or the swaying speed, which are represented by arrow 205, so as to move the cross cursor to any position.

In this example, when the map function prompts the user to select a certain position, a cross cursor 202 will be displayed at first. In that case, the user may click the cursor with the finger and drag it to the substantially required area. As the finger may shield the display content, and touching the touch screen with the finger cannot realize an accurate location, according to the method of the embodiment, the cross cursor 202 is dragged to the substantially required position at first. Then the finger is released, and the cross cursor is moved by slanting the smart phone all around through the gravity sensor 204 to perform a fine adjustment; after that, the obtained point is the finally selected position.

In the embodiment, the touch screen 203 of the electronic equipment 201 may be a liquid crystal display screen. But with the development of electronic technology, other types of display screens may also be used, and the embodiment is not limited thereto.

According to the method of the embodiment, the user can easily touch any point on a small-size liquid crystal display screen 203 under the accurate touch mode. Under the accurate touch mode, more complex contents (e.g., small-size mails or sophisticated images) can be displayed by swaying the liquid crystal display screen 203, because any point on the user interface of a certain application can be freely touched on the touch screen. Under the accurate touch mode, points close to the edge of the liquid crystal display screen can be easily selected.

In the embodiment, by swaying or slanting the electronic equipment having a touch screen 203, the display position of the cursor 202 is controlled using position movement information sensed by the gravity and acceleration sensor 204 to accurately locate a point, thereby improving the location accuracy of the touch screen and the user's experience.

### Embodiment 2

The embodiment of the present invention further provides a text selecting method. FIG. 3 is a flowchart of the method, and referring to FIG. 3, the method includes:

Step 301: determining an initial display position of a cursor displayed on a touch screen;

Step 302: acquiring position movement information from a gravity and acceleration sensor;

Step 303: calculating movement direction and distance of the cursor according to the position movement information;

Step 304: determining a current display position of the cursor according to the movement direction and distance of the cursor; and

Step 305: selecting a text of an area from the initial display position to the current display position as a target text.

In the embodiment, the user wants to select a text. But the operation is made through the touch screen, unlike the text selection through a mouse by pressing the left key of the mouse and moving toward the selected area. Especially, the text selection in an area magnified by a magnifier cannot be realized because the magnified area varies when the finger moves. Through the method of the embodiment, the user can carry out the text selection just by swaying or slanting the electronic equipment, and calculating the movement direction and distance of the cursor according to the position movement information sensed by the gravity and acceleration sensor.

In the embodiment, the method is used in the electronic equipment having a touch screen. In order to support the method of the embodiment, the work modes of the touch screen of the electronic equipment may be set in two types, for example a common touch mode and a text selection mode. Or by adding the method of the Embodiment 1, the work modes of the touch screen of the electronic equipment may be set in three types, for example a common touch mode, an accurate touch mode and a text selection mode. The common touch mode is the same as the work mode of the prior art and has been briefly described in Embodiment 1, thus it is not repeated herein. The accurate touch mode has been illustrated in Embodiment 1 and the content thereof is incorporated herein and not repeated. The text selection mode may be a work mode using the text selecting method of the embodiment. When the text selection mode is activated, a cursor will be displayed on the application interface of the electronic equipment, and the display position of the cursor is set as the initial display position, and then, the position movement information is acquired by swaying or slanting the electronic equipment, and the movement direction and distance of the cursor is calculated according to the position movement information. Then the current display position of the cursor is determined according to the movement direction and distance of the cursor, and a text of an area from the initial display position to the current display position of the cursor is taken as the target text.

In the embodiment, for example, the initial display position of the cursor in step 301 is determined in an initialization process.

In the embodiment, the implementations of steps 302 to 304 are the same as those of steps 101 to 103 in Embodiment 1, and the contents thereof are incorporated herein and not repeated.

In the embodiment, the text of the area from the initial display position to the current display position is taken as the target text in step 305. Herein, the target text may be highlighted or otherwise processed, for example temporarily stored in a buffer (or flash memory) and copied as the content of the clipboard.

To further describe this embodiment, an example is given as follows.

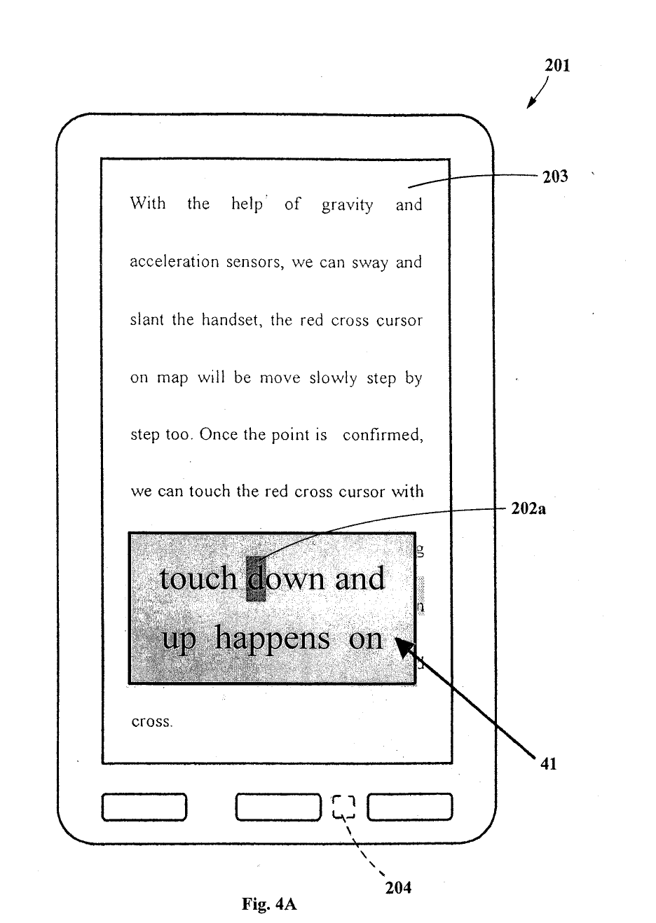

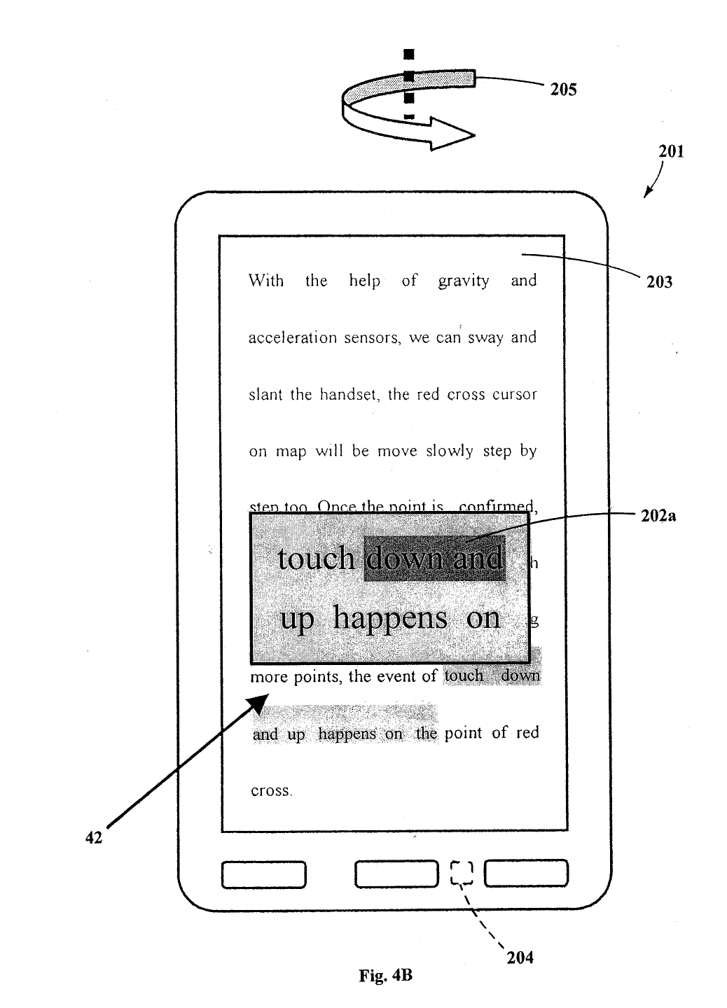

FIG. 4A is a schematic diagram in which a smart phone with the text display function activated using a magnifier at the text interface. FIG. 4B is a schematic diagram in which a target text is selected after the smart phone is swayed or slanted according to the method of the embodiment. Please refer to FIGS. 4A and 4B.

In the embodiment, when the user browses a zoomed out webpage, it is not easy to select some text or other content because the characters are too small, and the selected text or content will be magnified by a magnifier. However, for the magnifier, the user has to always touch the display screen downwards, and once the finger moves, the magnifier will magnify a different content based on the touch point. Thus it is very difficult to select some content in the magnifier. According to the method of the embodiment, some text in the magnifier may be focused.

Referring to FIG. 4A, a magnifier 41 magnifies characters “touch down and up happens on” displayed on the touch screen 203 of the smart phone 201. In that case, the cursor 202a is located in front of the letter “d” of the word “down”, and that position is the initial display position of the cursor. In FIG. 4A, the cursor 202a is a blinking cursor “|” commonly used in the existing personal computer is taken as an example.

Referring to FIG. 4B, since the content magnified by the magnifier varies with the touch position, the finger touch position cannot be changed, but some content in the magnifier may be focused according to the method of the embodiment. Firstly, the user sways or slants the smart phone from right to left, when the smart phone is swayed or slanted from right to left, the gravity and acceleration sensor 204 thereof will sense the movement and generate the position movement information. According to the method of the embodiment, i.e., the method as illustrated in FIG. 3, the movement direction and distance of the blinking cursor 202a are calculated after the smart phone moves to acquire the current display position of the blinking cursor, which is behind the word “and”. The text of the area from the initial display position to the current display position of the touch screen, i.e., “down and”, is taken as the target text. Thus according to the method of the embodiment, by swaying and slanting the smart phone, the focus portion of the magnifier 42 becomes more or less, as represented by the highlighted portion illustrated in FIG. 4B.

In this example, when characters are selected in a text magnified by a magnifier, a content selection cannot be carried out by moving the finger because the finger must always press the touch screen. According to the method of the embodiment, when characters need to be selected and viewed through a magnifier, the problem to be firstly solved is to select a character of the initial point in the magnifier. It is known that when the magnifier is used, the character content in the magnifier varies with the movement of the finger on the background character. According to the method of the embodiment, the first character or letter displayed in the magnifier, or the intermediate character or letter of those displayed in the magnifier may serve as the selected initial point. After the initial point is selected, the smart phone may be slanted all around (see arrow 205, for example), and a sensing may be made by a gravity and acceleration sensor 204 of the smart phone 201, so as to select more content according to the method of the embodiment. Finally, the finger is raised up to finish the application of the magnifier, and the content selected in the previous step is saved to the clipboard or highlighted. Of course, the content can be copied to other places.

The above example uses a text selection in the magnifier, but the embodiment is not limited thereto. In fact, the text selection function can also be used in the scenario of a general text display, not limited to the magnifier. In that case, being similar to the text selection in the magnifier, the start point of character selection is determined at first, then the gravity and acceleration sensor is used, and the smart phone is slanted all around, so as to select more content according to the method of the embodiment. Finally, like the current selection operation, the selected content is pressed until a prompt box for copying occurs, or other subsequent processing step is carried out.

In the embodiment, the touch screen of the electronic equipment may be a liquid crystal display screen. But with the development of the electronic technology, other types of display screens may also be used, and the embodiment is not limited thereto.

According to the method of the embodiment, the user can easily touch any point on a small-size liquid crystal display screen under the accurate touch mode. Under the accurate touch mode, more complex contents (e.g., small-size mails or sophisticated images) can be displayed by swaying the liquid crystal display screen, because any point on the user interface of a certain application can be freely touched on the touch screen. Under the accurate touch mode, points close to the edge of the liquid crystal display screen can be easily selected.

In the embodiment, by swaying or slanting the electronic equipment having a touch screen, the display position of a cursor is controlled using position movement information sensed by a gravity and acceleration sensor to locate and select a text area, thereby improving the location accuracy of the touch screen and user's experience.

To be noted, Embodiments 1 and 2 need not be independent from each other. That is, the two embodiments may be combined, for example, a certain point may be located by Embodiment 1, and a text may be selected by Embodiment 2, so as to simultaneously achieve the effects of accurate location and target area location.

### Embodiment 3

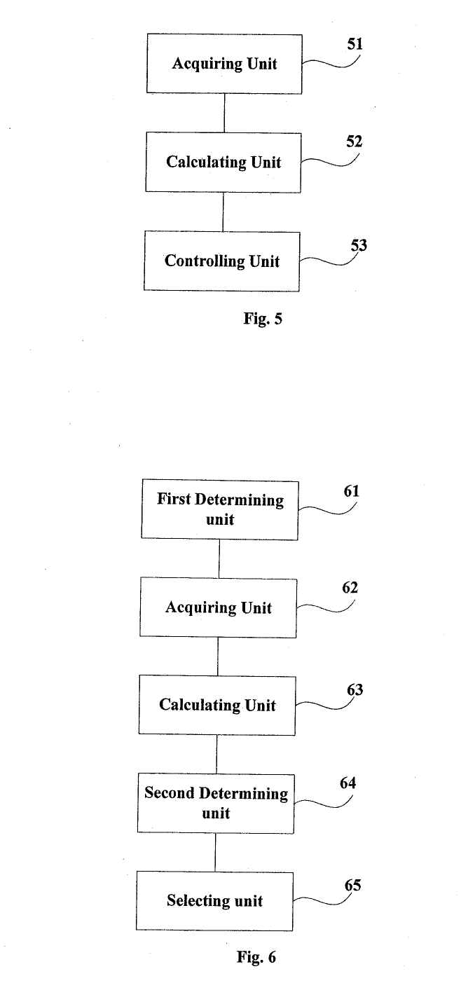

The embodiment of the present invention further provides a touch position locating device. FIG. 5 is a constitutional diagram of the device, and please refer to FIG. 5. The device includes:

an acquiring unit 51 for acquiring position movement information from a gravity and acceleration sensor;

a calculating unit 52 for calculating movement direction and distance of a cursor displayed on a touch screen according to the position movement information; and

a controlling unit 53 for controlling a display position of the cursor according to the movement direction and distance of the cursor.

Thus, the touch position can be determined according to the user's touch operation on the touch screen.

In the embodiment, the acquiring unit 51 may acquire the position movement information from a position sensing device such as the gravity and acceleration sensor. The position movement information may be movement direction, movement speed and/or displacement of the electronic equipment.

In the embodiment, the calculating unit 52 calculates the movement direction and distance of the cursor after the position movement information is acquired, according to the coordinates of the cursor displayed on the touch screen before the position movement information is acquired and the acquired position movement information. The coordinates of the cursor displayed on the touch screen before the position movement information is acquired are initial coordinates of the cursor, and are previously known to the touch position locating device.

The cursor may be a cross cursor, an arrow cursor, a blinking cursor or a cursor of other form.

In the embodiment, the controlling unit 53 controls the display position of the cursor according to the acquired movement direction and distance of the cursor.

In the embodiment, the touch position locating device may be used in the electronic equipment having a touch screen. Thus the position sensing device may be a gravity and acceleration sensor embedded in the electronic equipment.

Since the principle for the touch position locating device to solve its problem in the embodiment is similar to the touch position locating method in Embodiment 1, please refer to the implementation of the method of Embodiment 1 for the implementation of the touch position locating device, and herein is not repeated.

The embodiment of the present invention achieves the following beneficial effect: by swaying or slanting the electronic equipment having a touch screen, the display position of the cursor is controlled using the sensed position movement information to accurately locate a point, thereby improving the location accuracy of the touch screen and the user's experience.

### Embodiment 4

The embodiment of the present invention further provides a text selecting device. FIG. 6 is a constitutional diagram of the device, and please refer to FIG. 6, the device includes:

a first determining unit 61 for determining an initial display position of a cursor displayed on a touch screen;

an acquiring unit 62 for acquiring position movement information from a gravity and acceleration sensor;

a calculating unit 63 for calculating movement direction and distance of the cursor according to the position movement information;

a second determining unit 64 for determining a current display position of the cursor according to the movement direction and distance of the cursor; and

a selecting unit 65 for selecting a text of an area from the initial display position to the current display position as a target text.

Since the principle for the text selecting device to solve its problem in the embodiment is similar to the text selecting method in Embodiment 2, please refer to the implementation of the method of Embodiment 2 for the implementation of the text selecting device, and herein is not repeated.

The embodiment of the present invention achieves the following beneficial effect: by swaying or slanting the electronic equipment having a touch screen, the display position of the cursor is controlled using the sensed position movement information to locate an area, thereby improving the location accuracy of the touch screen and the user's experience.

### Embodiment 5

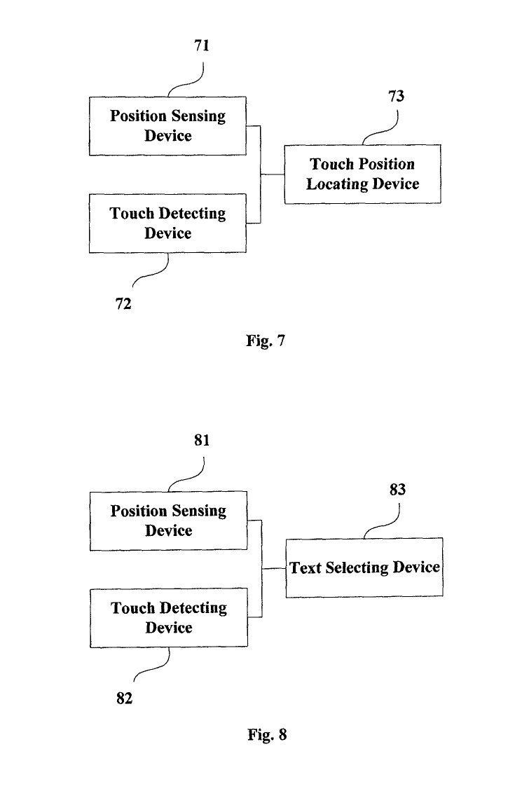

The embodiment of the present invention further provides an electronic equipment having a touch screen. FIG. 7 is a constitutional diagram of the electronic equipment, and please refer to FIG. 7, the electronic equipment includes:

a position sensing device 71 for sensing a movement of the electronic equipment to generate position movement information;

a touch detecting device 72 for detecting a user's touch operation on the touch screen of the electronic equipment to generate touch operation information; and

a touch position locating device 73 for acquiring the position movement information from the position sensing device 71, calculating movement direction and distance of a cursor according to the position movement information, and controlling a display position of the cursor according to the movement direction and distance of the cursor, so as to determine a touch position according to the touch operation information acquired from the touch detecting device 72.

In an example of the embodiment, the position sensing device 71 is a gravity and acceleration sensor.

In an example of the embodiment, the touch detecting device 72 is connected to the touch screen of the electronic equipment.

In the embodiment, the touch position locating device 73 may be implemented by the touch position locating device of Embodiment 3, and the content thereof in addition to the content of Embodiment 1 are incorporated herein and not repeated.

The embodiment of the present invention achieves the following beneficial effect: by swaying or slanting the electronic equipment having a touch screen, the display position of the cursor is controlled using the sensed position movement information to accurately locate a point, thereby improving the location accuracy of the touch screen and the user's experience.

### Embodiment 6

The embodiment of the present invention further provides an electronic equipment having a touch screen. FIG. 8 is a constitutional diagram of the electronic equipment, and please refer to FIG. 8, the electronic equipment includes:

a position sensing device 81 for sensing a movement of the electronic equipment to generate position movement information;

a touch detecting device 82 for detecting a user's touch operation on the touch screen of the electronic equipment to generate touch operation information; and

a text selecting device 83 for determining an initial display position of a cursor displayed on a touch screen, acquiring position movement information from the position sensing device 81, calculating movement direction and distance of the cursor according to the position movement information, determining a current display position of the cursor according to the movement direction and distance of the cursor, and selecting a text of an area from the initial display position to the current display position as a target text.

In an example of the embodiment, the position sensing device 81 is a gravity and acceleration sensor.

In an example of the embodiment, the touch detecting device 82 is connected to the touch screen of the electronic equipment.

In the embodiment, the text selecting device 83 may be implemented by the text selecting device of Embodiment 4, and the content thereof in addition to the content of Embodiment 2 are incorporated herein and not repeated.

The embodiment of the present invention achieves the following beneficial effect: by swaying or slanting the electronic equipment having a touch screen, the display position of the cursor is controlled using the sensed position movement information to locate an area, thereby improving the location accuracy of the touch screen and the user's experience.

The preferred embodiments of the present invention are described above with reference to the figures. The many features and advantages of the embodiments are apparent from the detailed specification and, thus, it is intended by the appended claims to cover all such features and advantages of the embodiments that fall within the true spirit and scope thereof. Further, since numerous modifications and changes will readily occur to those skilled in the art, it is not desired to limit the inventive embodiments to the exact construction and operation illustrated and described, and accordingly all suitable modifications and equivalents may be resorted to, falling within the scope thereof.

It should be understood that each of the parts of the present invention may be implemented by hardware, software, firmware, or a combination thereof. In the above embodiments, multiple steps or methods may be realized by software or firmware that is stored in the memory and executed by an appropriate instruction executing system. For example, if it is realized by hardware, it may be realized by any one of the following technologies known in the art or a combination thereof as in another embodiment: a discrete logic circuit having a logic gate circuit for realizing logic functions of data signals, application-specific integrated circuit having an appropriate combined logic gate circuit, a programmable gate array (PGA), and a field programmable gate array (FPGA), etc.

The description or blocks in the flowcharts or of any process or method in other manners may be understood as being indicative of including one or more modules, segments or parts for realizing the codes of executable instructions of the steps in specific logic functions or processes, and that the scope of the preferred embodiments of the present invention comprise other implementations, wherein the functions may be executed in manners different from those shown or discussed, including executing the functions according to the related functions in a substantially simultaneous manner or in a reverse order, which should be understood by those skilled in the art to which the present invention pertains.

The logic and/or steps shown in the flowcharts or described in other manners here may be, for example, understood as a sequencing list of executable instructions for realizing logic functions, which may be implemented in any computer readable medium, for use by an instruction executing system, device or apparatus (such as a system including a computer, a system including a processor, or other systems capable of extracting instructions from an instruction executing system, device or apparatus and executing the instructions), or for use in combination with the instruction executing system, device or apparatus. As used herein, “a computer readable medium” can be any device that can contain, store, communicate with, propagate or transmit programs for use by an instruction executing system, device or apparatus, or can be used with the instruction executing system, device or apparatus. A computer readable medium may be, for example, but not limited to, an electronic, magnetic, optical, electromagnetic, infrared or semiconductor system, device, apparatus, or a propagation medium. More particular examples (inexhaustive lists) of a computer readable medium may comprise the following: an electrical connecting portion (electronic device) having one or more wirings, a portable computer hardware box (magnetic device), a random access memory (RAM) (electronic device), a read-only memory (ROM) (electronic device), an erasable programmable read-only memory (EPROM or flash memory) (electronic device), an optical fiber (optical device), and a portable compact disk read-only memory (CDROM) (optical device). Furthermore, a computer readable medium may be paper or other appropriate media on which the programs may be printed, as the programs may be obtained electronically through scanning optically the paper or other appropriate media and then compiling, interpreting, or processing in other appropriate manners, as necessary, and then the programs are stored in the computer memory.

The above literal description and drawings show various features of the present invention. It should be understood that a person of ordinary skill in the art may prepare suitable computer codes to carry out each of the steps and processes described above and illustrated in the drawings. It should also be understood that the above-described terminals, computers, servers, and networks, etc. may be any type, and the computer codes may be prepared according to the disclosure contained herein to carry out the present invention by using the devices.

Particular embodiments of the present invention have been disclosed herein. Those skilled in the art will readily recognize that the present invention is applicable in other environments. In practice, there exist many embodiments and implementations. The appended claims are by no means intended to limit the scope of the present invention to the above particular embodiments. Furthermore, any reference to “a device to . . . ” is an explanation of device plus function for describing elements and claims, and it is not desired that any element using no reference to “a device to . . . ” is understood as an element of device plus function, even if the wording of “device” is included in that claim.

Although a particular preferred embodiment or embodiments have been shown and the present invention has been described, it is obvious that equivalent modifications and variants are conceivable to those skilled in the art in reading and understanding the description and drawings. Especially for various functions executed by the above elements (portions, assemblies, apparatus, and compositions, etc.), except otherwise specified, it is desirable that the terms (including the reference to “device”) describing these elements correspond to any element executing particular functions of these elements (i.e. functional equivalents), even though the element is different from that executing the function of an exemplary embodiment or embodiments illustrated in the present invention with respect to structure. Furthermore, although a particular feature of the present invention is described with respect to only one or more of the illustrated embodiments, such a feature may be combined with one or more other features of other embodiments as desired and in consideration of advantageous aspects of any given or particular application.

1. A touch position locating method, comprising:
acquiring position movement information from a gravity and acceleration sensor;
calculating movement direction and distance of a cursor displayed on a touch screen according to the position movement information; and
controlling a display position of the cursor according to the movement direction and distance of the cursor.

2. A text selecting method, comprising:
determining an initial display position of a cursor displayed on a touch screen;
acquiring position movement information from a gravity and acceleration sensor;
calculating movement direction and distance of the cursor according to the position movement information;
determining a current display position of the cursor according to the movement direction and distance of the cursor; and
selecting a text of an area from the initial display position to the current display position as a target text.

3. The method according to claim 1, wherein the position movement information comprises any combination of:
a movement direction;
a movement speed; and
a movement distance.

4. The method according to claim 1, wherein the cursor is a cross cursor, an arrow cursor or a blinking cursor.

5. A touch position locating device, comprising:
an acquiring unit for acquiring position movement information from a gravity and acceleration sensor;
a calculating unit for calculating movement direction and distance of a cursor displayed on a touch screen according to the position movement information; and
a controlling unit configured to control a display position of the cursor according to the movement direction and distance of the cursor.

6. A text selecting device, comprising:
a first determining unit for determining an initial display position of a cursor displayed on a touch screen;
an acquiring unit for acquiring position movement information from a gravity and acceleration sensor;
a calculating unit for calculating movement direction and distance of the cursor according to the position movement information;
a second determining unit for determining a current display position of the cursor according to the movement direction and distance of the cursor; and
a selecting unit for selecting a text of an area from the initial display position to the current display position as a target text.

7. An electronic equipment having a touch screen, wherein the electronic equipment comprises:
a position sensing device for sensing a movement of the electronic equipment to generate position movement information;
a touch detecting device for detecting a user's touch operation on the touch screen of the electronic equipment to generate touch operation information; and
a touch position locating device for acquiring the position movement information from the position sensing device, calculating movement direction and distance of a cursor according to the position movement information, controlling a display position of the cursor according to the movement direction and distance of the cursor, acquiring the touch operation information from the touch detecting device, and determining a touch position according to the touch operation information.

8. An electronic equipment having a touch screen, wherein the electronic equipment comprises:
a position sensing device for sensing a movement of the electronic equipment to generate position movement information;
a touch detecting device for detecting a user's touch operation on the touch screen of the electronic equipment to generate touch operation information; and
a text selecting device for determining an initial display position of a cursor displayed on a touch screen, acquiring position movement information from the position sensing device, calculating movement direction and distance of the cursor according to the position movement information, determining a current display position of the cursor according to the movement direction and distance of the cursor, and selecting a text of an area from the initial display position to the current display position as a target text.

9. The electronic equipment according to claim 7, wherein the position sensing device is a gravity and acceleration sensor.

10. The electronic equipment according to claim 7, wherein the touch detecting device is connected to the touch screen of the electronic equipment.

11. The method according to claim 2, wherein the position movement information comprises any combination of:
a movement direction;
a movement speed; and
a movement distance.

12. The method according to claim 2, wherein the cursor is a cross cursor, an arrow cursor or a blinking cursor.

13. The electronic equipment according to claim 8, wherein the position sensing device is a gravity and acceleration sensor.

14. The electronic equipment according to claim 7, wherein the touch detecting device is connected to the touch screen of the electronic equipment.
